(19) United States
(12) Patent Application Publication
(10) Pub. No.: US 2014/0212153 A1
(43) Pub. Date: Jul. 31, 2014

(54) IMAGE FORMING APPARATUS

(71) Applicants: TOSHIBA TEC KABUSHIKI KAISHA, Tokyo (JP); KABUSHIKI KAISHA TOSHIBA, Tokyo (JP)

(72) Inventor: Norio Tanaka, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 14/141,567

(22) Filed: Dec. 27, 2013

(30) Foreign Application Priority Data
Jan. 31, 2013 (JP) 2013-016879

(51) Int. Cl. G03G 15/00

(52) U.S. Cl. CPC G03G 15/553
USPC 399/18

(57) ABSTRACT

According to the exemplary embodiments, there is provided an image forming apparatus that has an image forming mode and an image erasing mode. The image forming apparatus has a display unit configured to perform an error display at the time of conveyance failure of a recording medium in the image forming mode and at the time of conveyance failure of the recording medium in the image erasing mode. In the image forming apparatus, the display unit changes the content of the error display at the time of conveyance failure of the recording medium in the image forming mode and at the time of conveyance failure of the recording medium in the image erasing mode.

### CROSS-REFERENCE TO RELATED APPLICATIONS

This application is based upon and claims the benefit of priority from the prior Japanese Patent Application No. 2013-16879, filed on Jan. 31, 2013, the entire contents of which are incorporated herein by reference.

### FIELD

The embodiments discussed herein generally relate to an image forming apparatus that has an image forming mode for forming an image on a recording medium and an image erasing mode for erasing the image formed on the recording medium.

### BACKGROUND

There have been known image forming apparatuses that have the image forming mode for forming an image on the recording medium, for example, a sheet, and the image erasing mode for erasing the image of the sheet.

For example, the image forming apparatus forms an image using a developer that maintains a visible state of being colored at a temperature less than a predetermined value, and enters an invisible state by being decolored at a temperature above the predetermined value. The sheet entered the invisible state by decoloring of the developer for forming the image, in other words, the sheet on which the image is erased can be reused as an image forming sheet.

In the image forming apparatus, a jam in which the sheet during conveying is stuck often occurs. When the jam occurs, the image forming apparatus stops the operation. When the sheet caused the jam is removed outside the apparatus by a user, the image forming apparatus resumes the operation. In many cases, the removed sheet is discarded by the user.

The removed sheet also includes the sheet on which the image is erased, in other words, the reusable sheet. Wasting the reusable sheet should be avoided as much as possible from the viewpoint of resource conservation.

### BRIEF DESCRIPTION OF THE DRAWINGS

FIG. 1 is a cross-sectional view illustrating the overall configuration of an image forming apparatus according to a first exemplary embodiment;

FIG. 2 is a cross-sectional view illustrating the configurations of a photosensitive drum of the image forming apparatus according to the first exemplary embodiment and peripheral portions thereof;

FIG. 3 is a block diagram illustrating a control configuration of the image forming apparatus according to the first exemplary embodiment;

FIG. 4 is a diagram illustrating an operation panel and a first guide screen of a display unit used in the image forming apparatus according to the first exemplary embodiment;

FIG. 5 is a flowchart illustrating a control operation of the image forming apparatus according to the first exemplary embodiment;

FIG. 6 illustrates the operation panel and a second guide screen of the display unit used in the image forming apparatus according to the first exemplary embodiment;

FIG. 7 is a flowchart illustrating a control operation of an image forming apparatus according to a second exemplary embodiment; and

FIG. 8 is a diagram illustrating the operation panel and a third guide screen of the display unit used in the image forming apparatus according to the second exemplary embodiment.

### DETAILED DESCRIPTION

According to the exemplary embodiments, there is provided an image forming apparatus that has an image forming mode and an image erasing mode. The image forming apparatus includes a process unit, a conveying unit, a display unit, and a control unit. In the image forming mode, the process unit performs a process of forming an image on a recording medium, and in the image erasing mode, the process unit performs a process of erasing the image formed on the recording medium. The conveying unit conveys the recording medium to the process unit, and discharges the recording medium after processing of the process unit to the outside of the apparatus. When the conveyance failure of the recording medium due to the conveying unit occurs, the display unit displays an error. The control unit determines whether the conveyance failure is a conveyance failure in the image forming mode or a conveyance failure in the image erasing mode, and controls the display unit to change the content of the error display in accordance with the determination result.

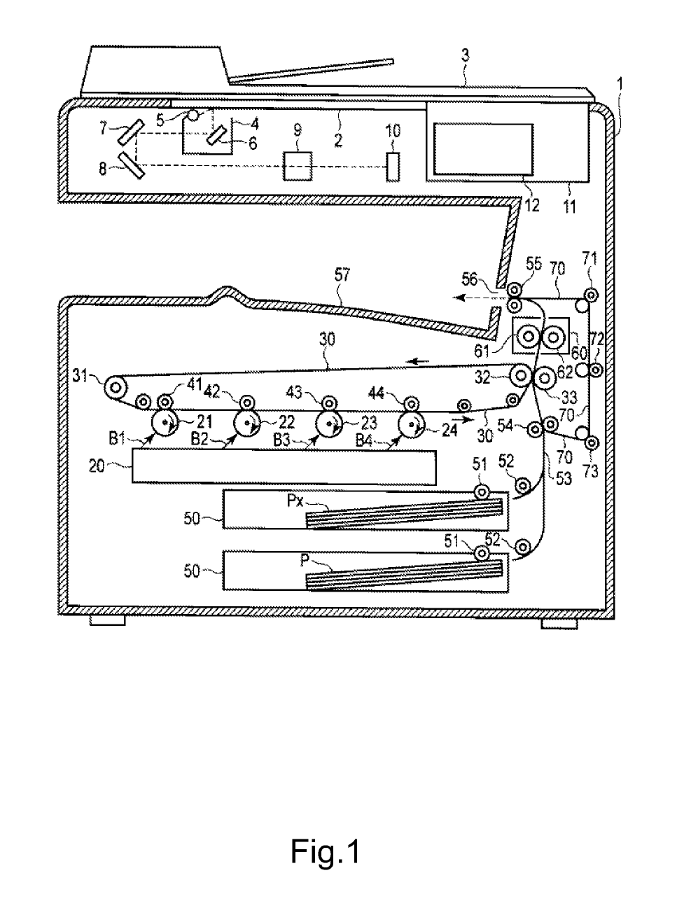

Hereinafter, further exemplary embodiments will be described while referring to the drawings. In the drawings, same reference numerals indicate the same or similar portions. The first exemplary embodiment will be described with reference to FIG. 1. FIG. 1 is a cross-sectional view illustrating the overall configuration of an image forming apparatus according to the first exemplary embodiment. As illustrated in FIG. 1, the image forming apparatus 1 has a copy holder 2, a cover 3, a carriage 4, and an exposure lamp 5. The copy holder 2 is placed at an upper part of a main body of the image forming apparatus 1. The copy holder 2 is formed with a transparent member, for example, a glass plate. The copy holder 2 holds an original copy placed by a user. The cover 3 is disposed on the copy holder 2 in a freely openable and closable manner. The carriage 4 is disposed on the lower surface side of the copy holder 2. The exposure lamp 5 is disposed in the carriage 4.

The image forming apparatus 1 includes a scanning unit 84 that reads an image of the original copy held by the copy holder 2. The scanning unit 84 has reflecting mirrors 6, 7, and 8, a variable magnification lens block 9, and a charge coupled device (CCD) 10 in addition to the carriage 4 and the exposure lamp 5. In the image reading operation of the scanning unit 84, the carriage 4 reciprocates along the lower surface of the copy holder 2. The exposure lamp 5 exposes the original copy on the copy holder 2 along with the forward movement of the carriage 4. The reflecting mirrors 6, 7 and 8 guide the reflected light caused by the exposure to the variable magnification lens block 9. The variable magnification lens block 9 optically and variably magnifies the image formed by the reflected light and guides the image to the CCD 10. The CCD 10 outputs an image signal of a level corresponding to the reflected light image.

The image forming apparatus 1 has an operation panel 11 subjected to operating conditions that are set by the user. The operation panel 11 is disposed in the vicinity of the copy holder 2. The operation panel 11 has a touch panel type liquid crystal display unit 12.

The image forming apparatus 1 has an exposure unit 20. For example, based on the image signal output by the CCD 10, the exposure unit 20 irradiates a laser beam B1 according to a yellow image signal, a laser beam B2 according to a magenta image signal, a laser beam B3 according to a cyan image signal, and a laser beam B4 according to a black image signal toward a photosensitive drum 21 as a yellow image carrier, a photosensitive drum 22 as a magenta image carrier, a photosensitive drum 23 as a cyan image carrier, and a photosensitive drum 24 as a black image carrier, respectively.

The image forming apparatus 1 has the photosensitive drums 21 to 24 and a transfer belt 30 serving as the image carrier. The photosensitive drums 21 to 24 are disposed along the transfer belt 30 side by side at regular intervals. In FIG. 1, the transfer belt 30 is disposed above the photosensitive drums 21 to 24. The transfer belt 30 is supported over a drive roller 31 and a driven roller 32. When receiving the power from the drive roller 31, the transfer belt 30 rotates in a counterclockwise direction.

The image forming apparatus 1 has primary transfer rollers 41, 42, 43, and 44. The primary transfer rollers to 44 are disposed at positions facing the photosensitive drums 21 to 24 via the transfer belt 30 in a freely vertically movable manner. The primary transfer rollers 41 to 44 transfer an image (an image of erasable toner to be described below) formed on the photosensitive drums 21 to 24 to the transfer belt 30, by rotating while pressing the transfer belt 30 against the peripheral surface of the photosensitive drums 21 to 24 in the image forming mode.

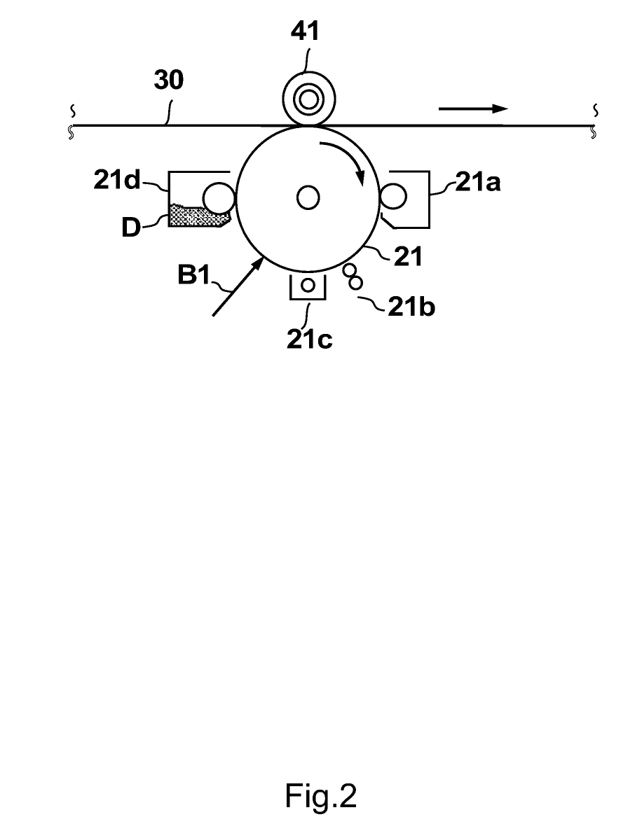

The configuration of the photosensitive drum 21 and the peripheral portion thereof will be described in more detail with reference to FIG. 2. FIG. 2 is a diagram illustrating the configuration of the photosensitive drum 21 and the peripheral portion thereof. As illustrated in FIG. 2, the image forming apparatus 1 has a cleaner 21a, a de-electrification lamp 21b, an electrification unit 21c, and a developing unit 21d. The cleaner 21a, the de-electrification lamp 21b, the electrification unit 21c, and the developing unit 21d are disposed around the photosensitive drum 21 in this order. The cleaner 21a removes the erasable toner remaining on the surface of the photosensitive drum 21 after transfer. The de-electrification lamp 21b removes the electric charge remaining on the surface of the photosensitive drum 21. The electrification unit 21c uniformly charges the surface of the photosensitive drum 21 by imparting an electrostatic charge on the surface of the photosensitive drum 21.

The exposure unit 20 forms an electrostatic latent image by irradiating the photosensitive drum 21 after charging with the laser beam B1. The developing unit 21d contains the yellow developer D. By supplying the erasable toner contained in the yellow developer D to the photosensitive drum 21, the developing unit 21d develops the electrostatic latent image to form an image of the yellow erasable toner.

The image forming apparatus 1 also includes the cleaner, the de-electrification lamp, the electrification unit, and the developing unit in the peripheral portions of other photosensitive drums 22, 23 and 24. Since the configuration of the peripheral portions of the photosensitive drums 22 to 24 is the same as the configuration of the peripheral portion of the photosensitive drum 21, a description thereof will not be provided. The photosensitive drums 22, 23 and 24 are formed with the image of the erasable toner of magenta, cyan, and black, respectively.

For example, the developer D of each color is a mixture of the erasable toner and a magnetic carrier. The erasable toner maintains a visible state of being colored at a temperature less than a predetermined value, and is decolored by being heated at a temperature equal to a predetermined value or more and enters an invisible state. The erasable toner includes a pigment and a color former. In a case in which an environmental temperature is lower than a predetermined value, for example, 120° C., the pigment and the color former are combined with each other. With the combination, the color of the pigment enters a visible state. In a case in which the environmental temperature is the predetermined value or more, the pigment and the color former eliminates the combination. By the elimination of combination, the color of the pigment enters the invisible state.

The image forming apparatus 1 has a plurality of sheet feeding cassettes 50. The sheet feeding cassettes 50 are disposed below the exposure unit 20. In the image forming mode, the sheet feeding cassettes 50 accommodate the sheet P of the image forming process target. The plurality of sheet feeding cassettes 50 accommodate a large number of sheets of different sizes. The sheet feeding cassette 50 located at the top of the plurality of the sheet feeding cassettes 50 is also used as a cassette for storing a sheet Px to be erased that is used in the image erasing mode.

The image forming apparatus 1 has a pickup roller 51, a sheet feeding roller 52, and a conveying path 53. The pickup roller 51 and the sheet feeding roller 52 are disposed for each of the plurality of the sheet feeding cassettes 50. Each of the pickup rollers 51 takes out the sheets P and Px in each of the sheet feeding cassettes 50 one by one. Each of the sheet feeding rollers 52 supplies the sheets P and Px taken out by each of the pickup rollers 51 to the conveying path 53.

The image forming apparatus 1 has a registration roller 54, a secondary transfer roller 33, a fixing unit 60, a sheet discharging rollers 55, a sheet discharging outlet 56, and a sheet discharging tray 57.

The conveying path 53 extends to the sheet discharging outlet 56 via the registration roller 54, the secondary transfer roller 33, the fixing unit 60, and the sheet discharging roller 55. The sheet discharging outlet 56 leads to the sheet discharging tray 57.

The sheet discharging roller 55 discharges the sheets P and Px to the sheet discharging tray 57 via the sheet discharging outlet 56. In a case of reversing the front side and back side of the sheets P and Px, by reversing the sheets during a period when the leading ends of the sheets P and Px temporarily exit the sheet discharging outlet 56, the sheet discharging roller 55 takes (switches back) the sheets P and Px into the apparatus, and supplies the sheets P and Px to a reversing unit described below. The sheet discharging tray 57 holds the sheets P and Px discharged by the sheet discharging roller 55.

The registration roller 54 is disposed at an upstream position of the secondary transfer roller 33 in the sheet conveying direction of the conveying path 53. The registration roller 54 conveys the sheet P fed by the sheet feeding roller 52 to the secondary transfer roller 33 in accordance with the rotation timing of the transfer belt 30 that carries the image of the erasable toner.

The secondary transfer roller 33 is disposed at a position facing the driven roller 32 with the transfer belt 30 and the conveying path 53 interposed therebetween. The secondary transfer roller 33 transfers the image of the erasable toner transferred onto the transfer belt 30 to the conveyed sheet P. The secondary transfer roller 33, the transfer belt 30, the drive roller 31, the driven roller 32, and the primary transfer rollers 41 to 44 constitute a transfer unit.

The image forming apparatus 1 has a reversing unit for reversing the front side and back side of the sheets P and Px. The reversing unit includes sheet feeding rollers 71, 72 and 73, and a conveying path 70. The conveying path extends to an upstream position of the registration roller 54 in the sheet conveying direction from the end of the conveying path 53. The sheet feeding rollers 71 to 73 and the conveying path 70 guide the switched-back sheets P and Px to the upstream position of the registration roller 54 by the sheet discharging roller 55.

The fixing unit 60 is a heating unit having a heat roller 61 and a pressure roller 62. In the image forming mode, the fixing unit 60 fixes the image of erasable toner transferred onto the sheet P in the visible state, by heating the sheet P of the image forming process target at a first temperature less than a predetermined value (for example, 120° C.), for example, at 100° C. by the heat roller 61. In the image erasing mode, the fixing unit 60 functions as an erasing unit. In the image erasing mode, the fixing unit 60 erases the image of the sheet Px, by heating the sheet Px to be erased at a second temperature equal to the predetermined value or more, for example, at 130° C. by the heat roller 61.

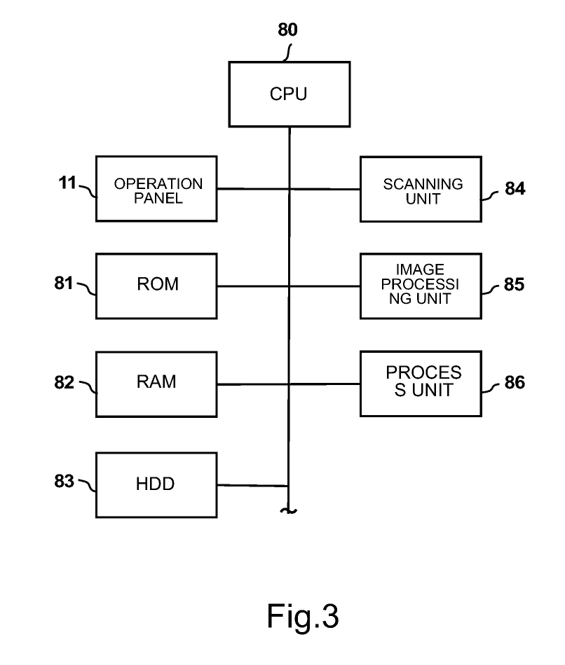

A control configuration of the image forming apparatus 1 will be described with reference to FIG. 3. FIG. 3 is a block diagram illustrating the control configuration of the image forming apparatus 1. As illustrated in FIG. 3, the image forming apparatus 1 has a central processing unit (CPU) 80 as a computer, the operation panel 11, a read only memory (ROM) 81, a random access memory (RAM) 82, a hard disk drive (HDD) 83, the scanning unit 84, an image processing unit 85, and a process unit 86. The CPU 80 is connected to the operation panel 11, the ROM 81, the RAM 82, the HDD 83, the scanning unit 84, the image processing unit 85, and the process unit 86.

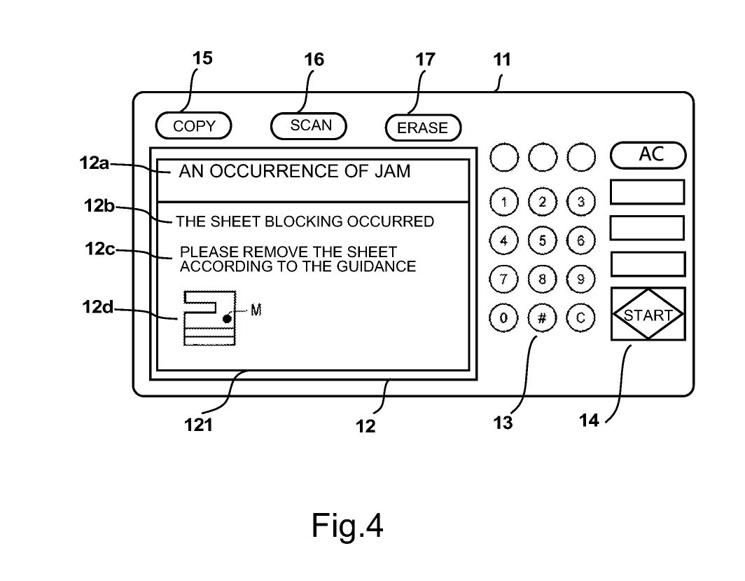

FIG. 4 is a diagram illustrating the operation panel and a first guide screen 121 of the liquid crystal display unit 12 used in the image forming apparatus 1. As illustrated in FIG. 4, the operation panel 11 has numeric keys 13, a start key 14, a copy key 15, a scan key 16, an erase key 17 and the like, in addition to the liquid crystal display unit 12 of the touch panel type. The copy key 15 accepts the setting of the image forming mode by a user. The scan key 16 accepts the setting of the image reading mode by the user. The erase key 17 accepts the setting of the image erasing mode by the user.

The ROM 81 stores various control programs. The RAM 82 stores various data. The HDD 83 stores the image data. As described above, the scanning unit 84 has the carriage 4, the exposure lamp 5, the reflecting mirrors 6 to 8, the variable magnification lens block 9, and the CCD 10, and optically scans and reads the image of the original copy on the copy holder 2. The image processing unit 85 processes the image signal to be output by the scanning unit 84 and converts the image into the image signal suitable for the image formation.

The process unit 86 has the exposure unit 20, the photosensitive drums 21 to 24, the transfer belt 30, the drive roller 31, the driven roller 32, the primary transfer rollers 41 to 44, the secondary transfer roller 33, the conveying path 53, the fixing unit 60, and the conveying path 70. The process unit 86 further has the cleaner, the de-electrification lamp, the electrification unit, the developing unit and the like described above disposed around the photosensitive drums 21 to 24. In the image forming mode, the process unit 86 forms the image on the sheet P, based on the image signal processed by the image processing unit 85.

Since the fixing unit 60 functions as the erasing unit, the process unit 86 erases the image formed on the sheet Px in the image erasing mode.

The CPU 80 is a control unit that controls the execution of the main functions of the image forming apparatus 1 based on the program in the ROM 81. The image forming apparatus 1 has an image forming function, an image erasing function, an error display function in the image forming mode, and an error display function in the image erasing mode, as the main functions. The image forming function is a function for forming an image on the sheet P. The operations of the scanning unit 84, the image processing unit 85, the process unit 86, and the conveying unit for conveying the sheet P are controlled by the CPU 80, and thus, the image forming apparatus 1 performs the image forming function in the image forming mode. The conveying unit in the image forming mode includes the pickup roller 51, the sheet feeding roller 52, the registration roller 54, and the sheet discharging roller 55, and includes the transfer belt 30 and the secondary transfer roller 33. In the image forming mode, the fixing unit 60 fixes the image formed on the sheet P. The copy key 15 of the operation panel 11 accepts the setting of the image forming mode by the user, and thus, the image forming apparatus 1 enters the image forming mode.

The image erasing function is a function to erase the image formed on the sheet Px. The image forming apparatus 1 performs the image erasing function in the image erasing mode, by controlling the operations of the fixing unit 60 of the process unit 86 and the conveying unit for conveying the sheet P by the CPU 80. The conveying unit in the image erasing mode includes the pickup roller 51, the sheet feeding roller 52, the registration roller 54, and the sheet discharging roller 55, and includes the transfer belt and the secondary transfer roller 33. In the image erasing mode, the fixing unit 60 erases the image formed on the sheet Px by functioning as the erasing unit. The erase key 17 of the operation panel 11 accepts the setting of the image erasing mode by the user, and thus the image forming apparatus 1 enters the image erasing mode.

The error display function in the image forming mode is a function that notifies the occurrence of the conveyance failure to the user when the conveyance failure of the sheet P due to the conveying unit occurs in the image forming mode, and guides the action required for cancelling the conveyance failure. In order to perform the error display function in the image forming mode, the CPU 80 of the image forming apparatus 1 controls the liquid crystal display unit 12. As illustrated in FIG. 4, the liquid crystal display unit 12 displays the first guide screen 121.

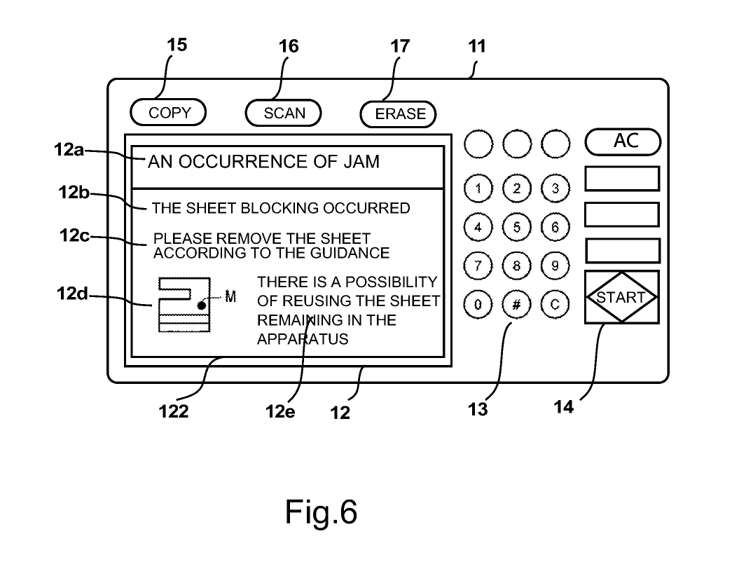

The error display function in the image erasing mode is a function that notifies the occurrence of the conveyance failure to the user when the conveyance failure of the sheet Px due to the conveying unit occurs in the image erasing mode, that guides the action required for cancelling the conveyance failure, and shows the possibility of reusing the sheet Px remaining in the image forming apparatus 1 due to the conveyance failure. In order to perform the error display function in the image erasing mode, the CPU 80 of the image forming apparatus 1 controls the liquid crystal display unit 12. As illustrated in FIG. 6, the liquid crystal display unit 12 displays the second guide screen 122.

The conveyance failure of the sheets P and Px due to the conveying unit includes the sheet jam occurring due to the breakdown of the conveying unit itself, and, for example, the sheet jam occurring by the deformation of the sheets P and Px. Hereinafter, the conveyance failures are collectively referred to as a jam.

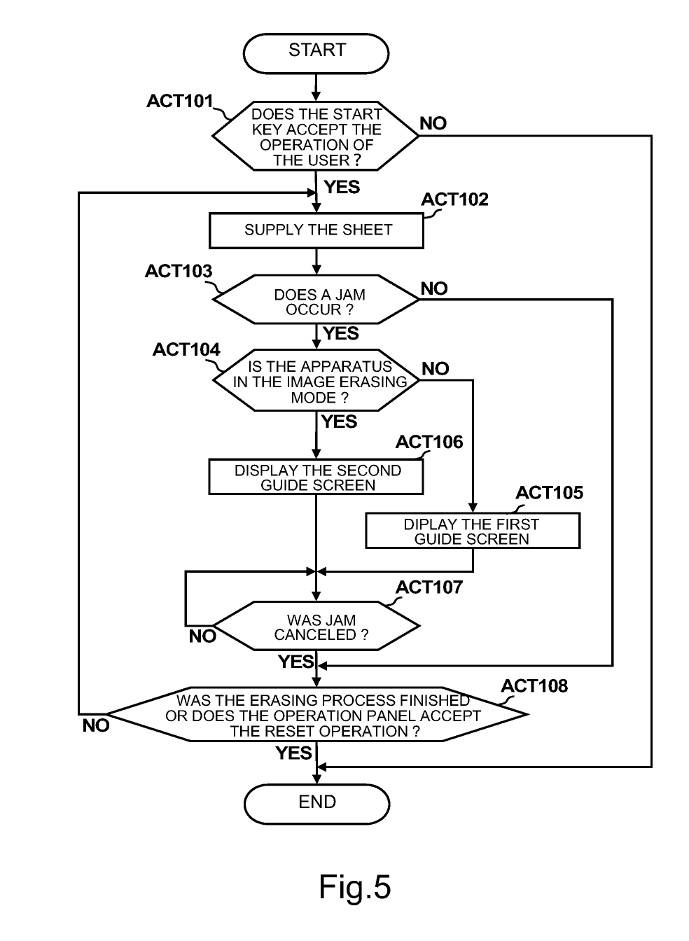

The control operation of the CPU 80 of the image forming apparatus 1 will be described with reference to FIG. 5. FIG. 5 is a flowchart for illustrating the control operation of the image forming apparatus. As illustrated in FIG. 5, in ACT 101, the CPU 80 determines whether or not the start key 14 of the operation panel 11 accepts the operation of the user. In a case in which the CPU 80 determines that the start key 14 accepted the operation of the user (YES in ACT 101), the operation of the image forming apparatus 1 proceeds to ACT 102. In ACT 102, the CPU 80 controls the operation of the pickup roller 51 and the sheet feeding roller 52 of one sheet feeding cassette 50 of the plurality of the sheet feeding cassettes 50. The pickup roller 51 and the sheet feeding roller 52 take the sheet out of the sheet feeding cassette 50, and supply the taken-out sheet to the conveying path 53.

Specifically, when the image forming apparatus 1 is in the image forming mode, the CPU 80 controls the operation of the pickup roller 51 and the sheet feeding roller 52 of the lower sheet feeding cassette 50 such that the sheet P accommodated in the lower sheet feeding cassette 50 is supplied to the conveying path 53. When the image forming apparatus 1 is in the image erasing mode, the CPU 80 controls the operation of the pickup roller 51 and the sheet feeding roller 52 of the uppermost sheet feeding cassette 50 such that the sheet Px accommodated in the uppermost sheet feeding cassette 50 is supplied to the conveying path 53.

In ACT 103, the CPU 80 determines whether or not the jam occurred in the conveying paths 53, and 70. Specifically, the CPU 80 monitors the positions of the sheets P and Px in the conveying paths 53 and 70, and the occurrence of the jam using a large number of sheet sensors disposed on the conveying paths 53 and 70. The CPU 80 determines whether or not the jam occurred based on the monitoring result.

When the CPU 80 determines the occurrence of jam (YES in ACT 103), the operation of the image forming apparatus 1 proceeds to ACT 104. In ACT 104, the CPU 80 temporarily interrupts the image forming process or the image erasing process in the process of being implemented. In ACT 104, the CPU 80 determines whether the image forming apparatus 1 is in the image erasing mode or in the image forming mode.

In other words, in ACT 103 and ACT 104, the CPU 80 determines whether the occurred jam is a jam in the image forming mode or a jam in the image erasing mode.

In ACT 104, in a case in which the CPU 80 determines that the image forming apparatus 1 is in the image forming mode (NO in ACT 104), the operation of the image forming apparatus 1 proceeds to ACT 105. In ACT 105, the CPU 80 controls the liquid crystal display unit 12 such that the first guide screen 121 is displayed. As illustrated in FIG. 4, the liquid crystal display unit 12 displays the first guide screen 121.

The first guide screen 121 includes a guidance letter 12a, for example, called “an occurrence of jam” for notifying the occurrence of jam. The first guide screen 121 includes a guidance letter 12b, for example, called “the sheet blocking occurred” for notifying the content of the occurrence of jam. The first guide screen 121 includes a guidance letter 12c, for example, called “please remove the sheet according to the guidance” for guiding the action required for cancelling the jam. The first guide screen 121 includes an image pattern 12d that notifies mark M of an occurrence position of the jam.

The user can know the occurrence of jam of the image forming sheet P, a method of cancelling the jam, the position of the jam or the like, by viewing the first guide screen 121. In this case, the sheet P to be taken out of the image forming apparatus 1 by the user is often discarded, unless it is very clean.

In ACT 104, in a case in which the CPU 80 determines that the image forming apparatus 1 is in the image erasing mode (YES in ACT 104), the operation of the image forming apparatus 1 proceeds to ACT 106. In ACT 106, the CPU 80 controls the liquid crystal display unit 12 so that second guide screen 122 is displayed. As illustrated in FIG. 6, the liquid crystal display unit 12 displays the second guide screen 122.

The second guide screen 122 includes a guidance letter 12e, for example, called “there is a possibility of reusing this sheet” for guiding the possibility of reusing the sheet Px remaining in the image forming apparatus 1 due to the jam, in addition to the guidance letters 12a, 12b and 12c, and the image pattern 12d.

The user can know the occurrence of jam of the sheet Px to be erased, the method of cancelling the jam, the position of the jam or the like, by viewing the second guide screen 122. Furthermore, the user can recognize that there is a possibility of reusing the sheet Px taken out of the image forming apparatus 1 so as to cancel the jam.

For example, even in a case in which the jammed sheet Px is present at a downstream position of the heat roller 61 of the fixing unit 60 in the sheet conveying direction, the image of the sheet Px is in the already erased state. The sheet Px can be reused as the image forming sheet P. Therefore, in order to cancel the jam, the user accommodates the sheet Px taken out of the image forming apparatus 1 in the lower sheet feeding cassette 50 for forming the image.

Even in a case in which the sheet Px is jammed at the position of the fixing unit 60 or in the vicinity thereof, for example, the image is formed only in a partial region of the sheet Px, and in a case in which the image portion passes through the heat roller 61, the image of the sheet Px is in the already erased state. The sheet Px can be reused as the image forming sheet P. Therefore, in order to cancel the jam, the user accommodates the sheet Px taken out of the image forming apparatus 1 in the lower sheet feeding cassette 50 for forming the image.

Therefore, according to the first exemplary embodiment, it is possible to avoid a situation that the reusable sheet Px is unexpectedly discarded, as much as possible, and it is possible to promote the reuse of sheet Px. Furthermore, since it is possible to promote the reuse of sheet Px, according to the first exemplary embodiment, it is possible to greatly contribute to the resource conservation and to make the best use of the image erasing function.

After the liquid crystal display unit 12 displays the first guide screen 121 in ACT 105, or after the liquid crystal display unit 12 displays the second guide screen 122 in ACT 105, the operation of the image forming apparatus 1 proceeds to ACT 107. In ACT 107, the CPU 80 determines whether the jam is cancelled by the action of the user. When the CPU 80 determines that the jam is cancelled by the action of the user, the operation of the image forming apparatus 1 proceeds to ACT 108. In ACT 108, the CPU 80 determines whether or not the image forming process or the erasing process of the number of sheets specified by the user is finished or whether or not the operation panel 11 accepts the reset operation of the user.

In ACT 108, in a case in which the CPU 80 determines that the image forming process or the image erasing process is not finished or the operation panel 11 does not accept the reset operation (NO in ACT 108), the operation of the image forming apparatus 1 returns to ACT 102. In ACT 102, the CPU 80 resumes the feeding of the followed sheets P and Px, by controlling the operation of the pickup roller 51 and the sheet feeding roller 52.

In ACT 108, in a case in which the CPU 80 determines that the image forming process or the image erasing process is finished or the operation panel 11 accepts the reset operation (YES in ACT 108), the CPU 80 finishes the operation of the image forming apparatus 1.

An image forming apparatus according to the second exemplary embodiment will be described. The image forming apparatus according to the second exemplary embodiment has the same configuration as the first exemplary embodiment illustrated in FIGS. 1 to 3. Hereinafter, the image forming apparatus according to the second exemplary embodiment is also referred to as the image forming apparatus 1. In the image forming apparatus 1 according to the second exemplary embodiment, the CPU 80 is a control unit that controls the implementation of the main function based on the program in the ROM 81. The image forming apparatus 1 has the image forming function, the image erasing function, the error display function in the image forming mode, the first error display function in the image erasing mode, and the second error display function in the image erasing mode, as the main functions.

As in the first exemplary embodiment, the image forming function is a function that forms an image on the sheet P. The operations of the scanning unit 84, the image processing unit 85, the process unit 86, and the conveying unit for conveying the sheet P are controlled by the CPU 80, and thus, the image forming apparatus 1 performs the image forming function in the image forming mode. The conveying unit in the image forming mode includes the pickup roller 51, the sheet feeding roller 52, the registration roller 54 and the sheet discharging roller 55, and includes the transfer belt 30 and the secondary transfer roller 33. In the image forming mode, the fixing unit 60 fixes the image formed on the sheet P. The copy key 15 of the operation panel 11 accepts the setting of the image forming mode by the user, and thus, the image forming apparatus 1 enters the image forming mode.

As in the first exemplary embodiment, the image erasing function is a function to erase the image formed on the sheet Px. The operations of the fixing unit 60 of the process unit 86 and the conveying unit for conveying the sheet P are controlled by the CPU 80, and thus, the image forming apparatus 1 performs the image erasing function in the image erasing mode. The conveying unit in the image erasing mode includes the pickup roller 51, the sheet feeding roller 52, the registration roller 54, and the sheet discharging roller 55, and includes the transfer belt and the secondary transfer roller 33. In the image erasing mode, the fixing unit 60 erases the image formed on the sheet Px by functioning as an erasing unit. The erase key 17 of the operation panel 11 accepts the setting of the image erasing mode by the user, and thus, the image forming apparatus 1 enters the image erasing mode.

As in the first exemplary embodiment, the error display function in the image forming mode is a function that notifies the occurrence of jam to the user when the jam occurs in the image forming mode, and guides the action required to cancel the jam. In the image forming apparatus 1, in order to perform the error display function in the image forming mode, the liquid crystal display unit 12 is controlled by the CPU 80. As illustrated in FIG. 4, the liquid crystal display unit 12 displays the first guide screen 121.

The first error display function in the image erasing mode is a function that notifies the occurrence of jam to the user in a case in which the sheet Px remaining in the image forming apparatus 1 due to the jam has already been erased in the image erasing mode, guides the action required for cancelling the jam, and guides the possibility of reusing the sheet Px. The case in which the sheet Px remaining in the image forming apparatus 1 due to the jam has already been erased is, for example, a case in which the jam of the sheet Px being conveyed occurs at a downstream position of the fixing unit 60 in the sheet conveying direction. The downstream position includes a position near the fixing unit 60. In order to perform the first error display function in the image erasing mode, the CPU 80 of the image forming apparatus 1 controls the liquid crystal display unit 12. As illustrated in FIG. 6, the liquid crystal display unit 12 displays the second guide screen 122.

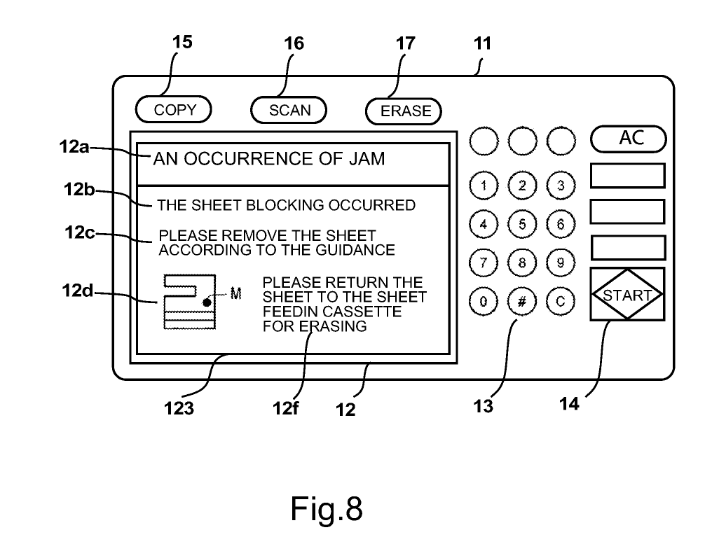

The second error display function in the image erasing mode is a function that notifies the occurrence of jam to the user in a case in which the sheet Px remaining in the image forming apparatus 1 due to the jam has not erased yet in the image erasing mode, shows the actions required for cancelling the jam, and promotes the repeated erasing process with respect to the sheet Px, for example, a function of providing the guidance to the effect of desiring to return the original sheet Px to the original sheet feeding cassette 50. The case in which the sheet Px remaining in the image forming apparatus 1 due to the jam has not been erased yet is, for example, a case in which the jam of the sheet Px being conveyed occurs at the upstream position of the fixing unit 60 in the conveying direction. In order to perform the second error display function in the image erasing mode, the CPU 80 of the image forming apparatus 1 controls the liquid crystal display unit 12. As illustrated in FIG. 8, the liquid crystal display unit 12 displays the third guide screen 123.

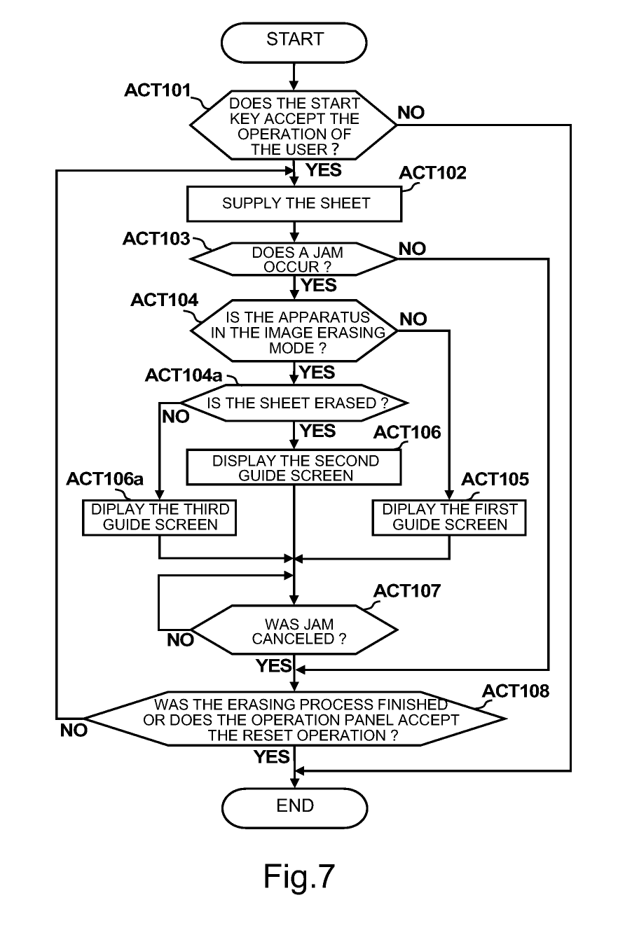

The control operation of the CPU 80 of the image forming apparatus 1 of the second exemplary embodiment will be described with reference to FIG. 7. FIG. 7 is a flowchart for illustrating the control operation of the image forming apparatus 1 of the second exemplary embodiment. In FIG. 7, the control different from the first exemplary embodiment and the relevant parts thereof will be described. As illustrated in FIG. 7, when the CPU 80 determines the occurrence of jam in ACT 103 (YES in ACT 103), the operation of the image forming apparatus 1 proceeds to ACT 104. In ACT 104, the CPU 80 determines whether the image forming apparatus 1 is in the image erasing mode or in the image forming mode.

When the CPU 80 determines that the image forming apparatus 1 is in the image forming mode (NO in ACT 104), the operation of the image forming apparatus 1 proceeds to ACT 105. In ACT 105, the CPU 80 controls the liquid crystal display unit 12 such that the first guide screen 121 is displayed. As illustrated in FIG. 4, the liquid crystal display unit 12 displays the first guide screen 121.

In ACT 104, when the CPU 80 determines that the image forming apparatus 1 is in the image erasing mode (YES in ACT 104), the operation of the image forming apparatus 1 proceeds to ACT 104a. In ACT 104a, the CPU 80 determines whether or not the sheet Px remaining in the image forming apparatus 1 due to the jam has already been erased by the fixing unit 60.

When it is determined that the sheet Px remaining in the image forming apparatus 1 due to the jam has already been erased by the fixing unit 60, the CPU 80 determines that there is a possibility of reusing the sheet Px. When it is determined that the sheet Px remaining in the image forming apparatus 1 due to the jam has not been erased by the fixing unit 60 yet, the CPU 80 determines that there is no possibility of reusing the sheet Px.

When the CPU 80 determines that the sheet Px remaining in the image forming apparatus 1 due to the jam has already been erased by the fixing unit 60 in ACT 104a (YES in ACT 104a), the operation of the image forming apparatus 1 proceeds to ACT 106. The CPU 80 controls the liquid crystal display unit 12 so that the second guide screen 122 is displayed. As illustrated in FIG. 6, the liquid crystal display unit 12 displays the second guide screen 122.

The user can know the occurrence of jam of the sheet Px to be erased, the method of canceling the jam, the position of the jam, or the like, by viewing the second guide screen 122. Furthermore, the user can recognize that there is a possibility of reusing the sheet Px taken out of the image forming apparatus 1 for cancelling the jam.

For example, when the jammed sheet Px is present at the downstream position of the heat roller 61 of the fixing unit 60 in the sheet conveying direction, the image of the sheet Px is in the already erased state. The sheet Px can be reused as the sheet P for forming the image. Therefore, in order to cancel the jam, the user accommodates the sheet Px taken out of the image forming apparatus 1 in the lower sheet feeding cassette 50 for forming the image.

Even when the sheet Px is jammed at the position of the fixing unit 60 or in the vicinity thereof, for example, the image is formed only in a partial region of the sheet Px, and when the image portion passes through the heat roller 61, the image of the sheet Px is already in the erased state. The sheet Px can be reused as the sheet P for forming the image. Therefore, in order to cancel the jam, the user accommodates the sheet Px taken out of the image forming apparatus 1 in the lower sheet feeding cassette 50 for forming the image.

When the CPU 80 determines that the sheet Px remaining in the image forming apparatus 1 due to the jam has not been erased by the fixing unit 60 yet in ACT 104a (NO in ACT 104a), the operation of the image forming apparatus 1 proceeds to ACT 106a. In ACT 106a, the CPU 80 controls the liquid crystal display unit 12 such that the third guide screen 123 is displayed. As illustrated in FIG. 8, the liquid crystal display unit 12 displays the third guide screen 123.

The third guide screen 123 includes a guidance letter 12f, for example, “please return the sheet to the sheet feeding cassette for erasing” for facilitating the erasing process again with respect to the sheet Px remaining in the image forming apparatus 1 due to the jam, in addition to the guidance letters 12a, 12b, and 12c, and the image pattern 12d.

In order to know the occurrence of jam of the sheet Px to be erased, the method of cancelling the jam, the position of the jam or the like, by viewing the third guide screen 123, the user is able to recognize that the sheet Px taken out of the image forming apparatus 1 has not been erased yet.

When the sheet Px remaining in the image forming apparatus 1 due to the jam is present on the upstream side of the heat roller 61 in the sheet conveying direction of the fixing unit 60, the image of the sheet Px is in the state that has not been erased yet. Therefore, the sheet Px can be used without waste by accommodating the sheet Px in the uppermost sheet feeding cassette 50 for erasing again. In order to cancel the jam, the user accommodates the sheet Px taken out of the image forming apparatus 1 in the uppermost sheet feeding cassette 50 according to the display of the guidance letter 12f of the third guide screen 123.

Therefore, according to the second exemplary embodiment, it is also possible to avoid the situation in which the sheet Px that has not been erased yet is discarded as well as the situation in which the sheet Px which becomes reusable is unexpectedly discarded. In addition, according to the second exemplary embodiment, since it is possible to promote the reuse and use of the sheet Px, it is possible to greatly contribute to the resource conservation, and it is possible to make the most of the image erasing function.

In order to execute the above-mentioned error display function, various modifications can be made to the content of the guidance letters and the image patterns displayed by the liquid crystal display unit 12, without being limited to the guidance letters 12a, 12b, 12c, and 12e, and the image pattern 12d. The content of the guidance letters and the image patterns may be suitably selected according to the culture, the language or the like of the region where the image forming apparatus 1 is used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus that has an image forming mode and an image erasing mode, the apparatus comprising:
a process unit configured to perform a process of forming an image on a recording medium in the image forming mode, and to perform a process of erasing the image formed on the recording medium in the image erasing mode;
a conveying unit configured to convey the recording medium to the process unit, and to discharge the recording medium after the process using the process unit to the outside of the apparatus;
a display unit configured to perform an error display when a conveyance failure of the recording medium due to the conveying unit occurs; and
a control unit configured to determine whether the conveyance failure is a conveyance failure in the image forming mode or a conveyance failure in the image erasing mode, and to control the display unit to change the content of the error display depending on the determination result.

2. The image forming apparatus according to claim 1,
wherein when the control unit determines the conveyance failure in the image forming mode, the display unit notifies that the conveyance failure occurs, and displays a first guide screen that shows a method of cancelling the conveyance failure, as the error display.

3. The image forming apparatus according to claim 2,
wherein when the control unit determines the conveyance failure in the image erasing mode, the display unit displays a second guide screen that shows the possibility of reusing the recording medium remaining in the apparatus at the time of the conveyance failure, as the error display.

4. The image forming apparatus according to claim 3,
wherein when the control unit determines the conveyance failure in the image erasing mode, the control unit determines that there is the possibility of reusing the recording medium remaining in the apparatus at the time of the conveyance failure, and controls the display unit to change the content of the error display depending on the determination result.

5. The image forming apparatus according to claim 4,
wherein when the control unit determines that there is a possibility of reusing the recording medium remaining in the apparatus at the time of the conveyance failure, the display unit displays the second guide screen.

6. The image forming apparatus according to claim 5,
wherein when the control unit determines that there is no possibility of reusing the recording medium remaining in the apparatus at the time of the conveyance failure, the display unit displays a third guide screen different from the second guide screen, as the error display.

7. The image forming apparatus according to claim 6,
wherein the control unit determines that there is the possibility of reusing the recording medium, by determining whether or not the recording medium remaining in the apparatus at the time of the conveyance failure is erased.

8. The image forming apparatus according to claim 7,
wherein when it is determined that the recording medium remaining in the apparatus at the time of the conveyance failure is erased, the control unit determines there is a possibility of reusing the recording medium, and when it is determined that the recording medium remaining in the apparatus at the time of the conveyance failure is not erased, the control unit determines there is no possibility of reusing the recording medium.

9. The image forming apparatus according to claim 8,
wherein when the control unit determines that there is no possibility of reusing the recording medium remaining in the apparatus at the time of the conveyance failure, the display unit displays the third guide screen including the guidance that promotes the repeated image erasing process.

10. The image forming apparatus according to claim 9,
wherein the control unit determines whether or not the recording medium is erased depending on the position of the recording medium remaining in the apparatus at the time of the conveyance failure.
